(19) United States
(12) Patent Application Publication
(10) Pub. No.: US 2024/0346416 A1
(43) Pub. Date: Oct. 17, 2024

(54) INFORMATION PROCESSING APPARATUS, INFORMATION PROCESSING SYSTEM, INFORMATION PROCESSING METHOD, AND NON-TRANSITORY RECORDING MEDIUM

(71) Applicants: Kota Ogasawara, KANAGAWA (JP); Hiroaki Nagata, KANAGAWA (JP); Tsuyoshi Ueno, KANAGAWA (JP)

(72) Inventors: Kota Ogasawara, KANAGAWA (JP); Hiroaki Nagata, KANAGAWA (JP); Tsuyoshi Ueno, KANAGAWA (JP)

(73) Assignee: Ricoh Company, Ltd., Tokyo (JP)

(21) Appl. No.: 18/618,196

(22) Filed: Mar. 27, 2024

(30) Foreign Application Priority Data
Apr. 12, 2023 (JP) 2023-065105

(51) Int. Cl. G06Q 10/0631

(52) U.S. Cl. CPC G06Q 10/06316; G06Q 10/063114; G06Q 10/063116

(57) ABSTRACT

An apparatus, system, method, and a program stored on a non-transitory recording medium, each of which: acquires a registered task arranged in a schedule; arranges a new task in the schedule, based on the arrangement of the registered task; and changes the arrangement of the registered task, based on the arrangement of the new task.

### CROSS-REFERENCE TO RELATED APPLICATIONS

This patent application is based on and claims priority pursuant to 35 U.S.C. § 119(a) to Japanese Patent Application No. 2023-065105, filed on Apr. 12, 2023, in the Japan Patent Office, the entire disclosure of which is hereby incorporated by reference herein.

### BACKGROUND

### Technical Field

The present disclosure relates to an information processing apparatus, an information processing system, an information processing method, and a non-transitory recording medium.

### Related Art

An information processing apparatus that enables linkage of task management and schedule management is used.

For example, a schedule editing program for editing a schedule is disclosed. The schedule editing program receives registration of a schedule of a task, and automatically registers the task and a predetermined event in the schedule when a time slot that is permissible as an allocation destination of the task and that is other than a time slot associated with a registered task has a time length for the task.

### SUMMARY

Example embodiments include an apparatus, system, method, and a program stored on a non-transitory recording medium, each of which: acquires a registered task arranged in a schedule; arranges a new task in the schedule, based on the arrangement of the registered task; and changes the arrangement of the registered task, based on the arrangement of the new task.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an illustration of an example of a general arrangement of an information processing system according to a first embodiment;

FIG. 2 is a block diagram illustrating an example of a hardware configuration of a computer according to the first embodiment;

FIG. 3 is a block diagram illustrating an example of a functional configuration of the information processing system according to the first embodiment;

FIG. 4 is a diagram illustrating an example of task information according to the first embodiment;

FIG. 5 is a sequence diagram illustrating an example of an information processing method according to the first embodiment;

FIG. 6 is a diagram illustrating an example of a task input screen according to the first embodiment;

FIG. 7 is a flowchart illustrating an example of a task input process according to the first embodiment;

FIG. 8 is a flowchart illustrating an example of a schedule optimization process according to the first embodiment;

FIG. 9 is a diagram illustrating an example of a schedule screen according to the first embodiment;

FIG. 10 is a diagram illustrating an example of the schedule screen according to the first embodiment;

FIG. 11 is a diagram illustrating an example of the schedule screen according to the first embodiment;

FIG. 12 is a diagram illustrating an example of the schedule screen according to the first embodiment;

FIG. 13 is a block diagram illustrating an example of a functional configuration of an information processing system according to a second embodiment;

FIG. 14 is a sequence diagram illustrating an example of an information processing method according to the second embodiment; and

FIG. 15 is a diagram illustrating an example of a progress input screen according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In the technique of the related art, changing the schedule of the registered task is not considered. For example, even if a new task with a higher priority occurs, the new task is not arranged before a registered task with a lower priority in some cases. In view of this, a technique for recommending the user with a schedule of tasks that the user can work efficiently is described below.

### First Embodiment

An information processing system according to a first embodiment provides a management assistance service in which task management and schedule management are linked. The management assistance service in the present embodiment has a function of automatically arranging a task input by a user in a schedule and optimizing arrangement of tasks in accordance with registration of a new task or the progress of the registered task.

### General Arrangement of Information Processing System

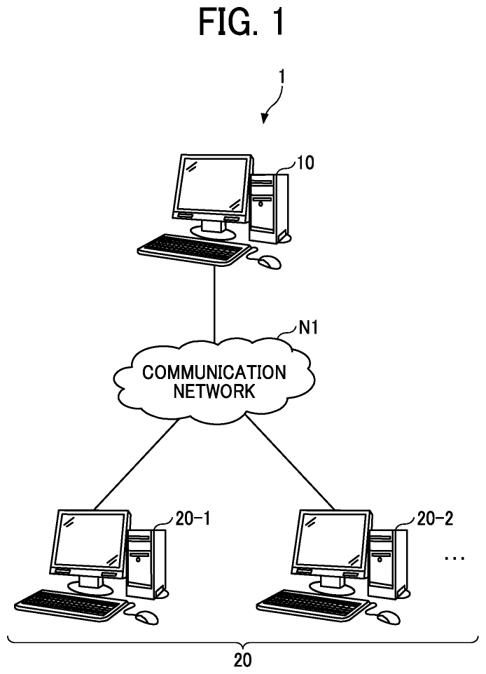

A general arrangement of the information processing system according to the present embodiment will be described with reference to FIG. 1. FIG. 1 is an illustration of an example of a general arrangement of the information processing system according to the present embodiment.

As illustrated in FIG. 1, an information processing system 1 according to the present embodiment includes a task management apparatus 10 and one or more user terminals 20.

The task management apparatus 10 and the user terminals 20 (20-1, 20-2, etc.) are each connected to a communication network N1. The communication network N1 allows apparatuses connected thereto to communicate with one another.

The communication network N1 includes, for example, a wired communication network such as Internet, a local area network (LAN), or a wide area network (WAN). The communication network N1 may also include, for example, a wireless communication network such as a wireless LAN or a network of short-range wireless communication, or a mobile communication network such as Worldwide Interoperability for Microwave Access (WiMAX), Long Term Evolution (LTE), or 5th Generation (5G), in addition to the wired communication network.

The task management apparatus 10 is an information processing apparatus that provides the management assistance service to the user terminals 20 via the communication network N1. The task management apparatus 10 may be implemented by a single information processing apparatus, or may be a system implemented by a plurality of information processing apparatuses.

The user terminals 20 are information processing apparatuses to be operated by the users of the information processing system 1. The users of the information processing system 1 use the user terminals 20 to use the management assistance service provided by the task management apparatus 10.

Hereinafter, when the plurality of user terminals 20 are distinguished from one another, the user terminals 20 are represented with branch numbers such as “user terminal 20-1” and “user terminal 20-2”.

An example of the task management apparatus 10 and the user terminals 20 is computers. The user terminals 20 are not limited to computers and may be any apparatuses having a communication function. The user terminals 20 may be, for example, an image forming apparatus (a printer, a facsimile machine, a multifunction peripheral/product/printer (MFP), or a scanner), a projector (PJ), an interactive whiteboard (IWB) having an electronic whiteboard function with interactive communication, an output device such as a digital signage, a head-up display (HUD), an industrial machine, an image-capturing device, a sound-collecting device, a medical equipment, a network-connected home appliance, an automobile (connected car), a notebook personal computer (PC), a mobile phone, a smart phone, a tablet terminal, a gaming machine, a personal digital assistant (PDA), a digital camera, a wearable PC, or a desktop PC.

The configuration of the information processing system 1 illustrated in FIG. 1 is merely an example. The information processing system 1 may have another configuration. For example, the information processing system 1 according to the present embodiment may include various devices that perform at least one of input and output of electronic data. These devices may use the various services provided by the task management apparatus 10.

### Hardware Configuration of Information Processing System

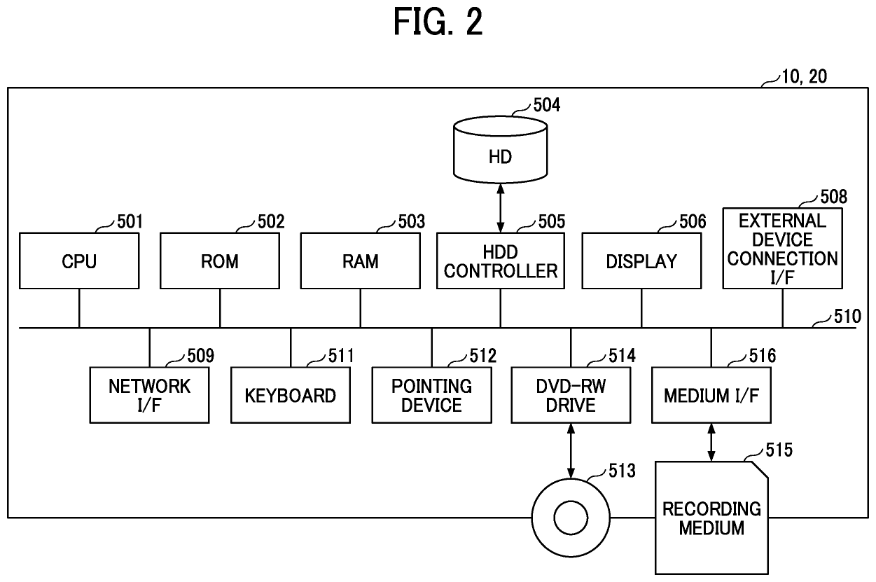

A hardware configuration of each of the apparatuses included in the information processing system 1 according to the present embodiment will be described with reference to FIG. 2.

### Hardware Configuration of Computer

The task management apparatus 10 and the user terminals 20 according to the present embodiment may each be implemented, for example, by a computer. FIG. 2 is a block diagram illustrating an example of a hardware configuration of the computer according to the present embodiment.

As illustrated in FIG. 2, the computer according to the present embodiment includes a central processing unit (CPU) 501, a read-only memory (ROM) 502, a random access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a medium I/F 516.

The CPU 501 controls entire operation of the computer. The ROM 502 stores an initial program loader (IPL) or any other program used for booting the CPU 501. The RAM 503 is used as a work area for the CPU 501. The HD 504 stores various kinds of data such as a program. The HDD controller 505 controls reading or writing of various kinds of data from or to the HD 504 under control of the CPU 501.

The display 506 displays various kinds of information such as a cursor, a menu, a window, characters, or an image. The external device connection I/F 508 is an interface for connecting various external devices. Examples of the external devices in this case include, but are not limited to, a Universal Serial Bus (USB) memory and a printer. The network I/F 509 is an interface for data communication via the communication network N1. The bus line 510 is, for example, an address bus or a data bus for electrically connecting the components such as the CPU 501 illustrated in FIG. 2 to one another.

The keyboard 511 is an example of an input device provided with a plurality of keys with which characters, numerical values, various instructions, and the like are input. The pointing device 512 is an example of an input device used to select or execute various instructions, select a target for processing, or move a cursor. The DVD-RW drive 514 controls reading or writing of various kinds of data from or to a DVD-RW 513, which is an example of a removable recording medium. The removable recording medium is not limited to the DVD-RW and may be a digital versatile disk-recordable (DVD-R) or the like. The medium I/F 516 controls reading or writing (storing) of data from or to a recording medium 515 such as a flash memory.

### Functional Configuration of Information Processing System

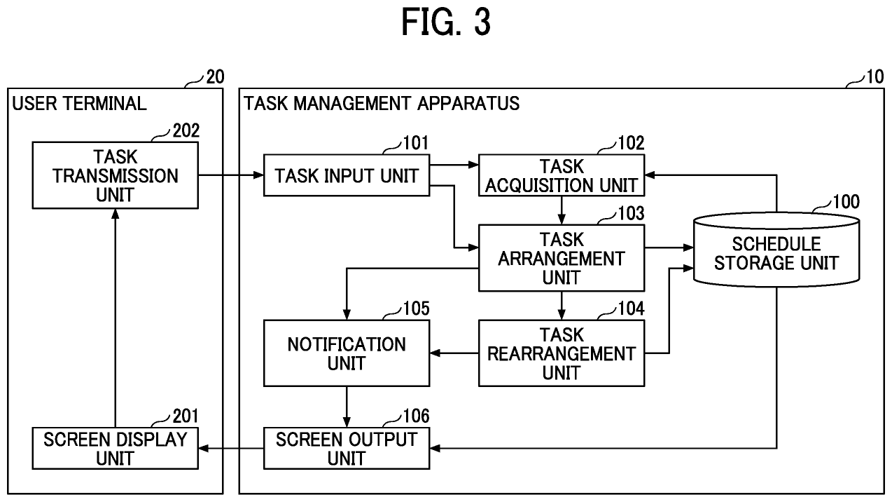

A functional configuration of the information processing system 1 according to the present embodiment will be described with reference to FIG. 3. FIG. 3 is a block diagram illustrating an example of the functional configuration of the information processing system according to the present embodiment.

### Functional Configuration of Task Management Apparatus

As illustrated in FIG. 3, the task management apparatus 10 according to the present embodiment includes a schedule storage unit 100, a task input unit 101, a task acquisition unit 102, a task arrangement unit 103, a task rearrangement unit 104, a notification unit 105, and a screen output unit 106.

The schedule storage unit 100 is implemented, for example, using the HD 504 illustrated in FIG. 2. Reading or writing of data stored or to be stored in the HD 504 is performed via the HDD controller 505, for example.

The task input unit 101, the task acquisition unit 102, the task arrangement unit 103, the task rearrangement unit 104, the notification unit 105, and the screen output unit 106 are implemented by processes executed by the CPU 501, for example, as a result of the CPU 501 executing a program loaded from the HD 504 into the RAM 503 illustrated in FIG. 2.

The schedule storage unit 100, which may be implemented by any desired memory such as the HD 504, stores schedule information indicating a schedule of a user. The schedule information is stored for each user. The schedule information includes information on a date and time, and information on a task arranged on that date and time. The schedule storage unit 100 may be any memory other than the local memory of the task management apparatus 10, as long as it is accessible from the task management apparatus 10.

Note that arranging a task means to associate a task to be performed in a time slot with that time slot. In the present embodiment, an example is described in which a single task is arranged in a certain time slot. However, a plurality of tasks may be arranged a certain time slot.

The task input unit 101 receives input of a new task. A new task is a task that has not been arranged in the schedule. That is, a new task is a task for which a time slot for execution has not been determined.

In the present embodiment, the task input unit 101 receives information on a new task from the user terminal 20 to receive input of the new task. The task input unit 101 may receive a new task input from input devices such as the keyboard 511 and the pointing device 512 of the task management apparatus 10.

### Task Information

Hereinafter, information on a task is also referred to as “task information”. Task information on a new task is referred to as “new task information”.

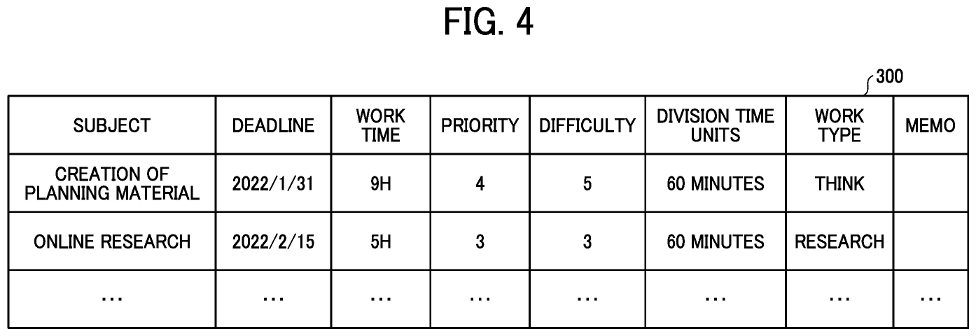

FIG. 4 is a diagram illustrating an example of the task information according to the present embodiment. As illustrated in FIG. 4, task information 300 according to the present embodiment includes, for example, items such as “subject”, “deadline”, “work time”, “priority”, “difficulty”, “division time units”, “work type”, and “memo”.

The division time units are time units by which a new task is divided when the new task is arranged in the schedule. For example, if a task has a long work time, dividing the task into a plurality of segments and arranging the segments in the schedule may increase the work efficiency. In the present embodiment, the work time of a new task is divided by the division time units, and divisional tasks obtained by the division are each arranged in the schedule.

The work type is information indicating characteristics of the work of the task. Examples of the work type include “think”, “research”, and “simple”. When the daily life cycle of the user is taken into account, it may be effective to arrange a task in a time slot suitable for the characteristics of the work. For example, a task of “think” type involves concentration. Therefore, the efficiency of such a task is likely to increase if the task is arranged in the morning when the level of fatigue is low. For example, a task of “simple” type may be arranged in the evening. This makes it easier to preferentially arrange other tasks in the morning.

The items of the task information are not limited to these items. The task information can include various kinds of information for use in management of a task.

Referring back to FIG. 3, the description is continued. The task acquisition unit 102 acquires a registered task from the schedule information read from the schedule storage unit 100. A registered task is a task that has been arranged in the schedule. That is, a registered task is a task for which a time slot for execution has been determined.

The task arrangement unit 103 arranges a new task received by the task input unit 101 in the schedule. Specifically, based on the division time units, the task arrangement unit 103 divides the new task into a plurality of divisional tasks. Then, based on at least one of the deadline, the priority, the difficulty, or the work type of the new task, the task arrangement unit 103 determines the arrangement of each of the divisional tasks.

Based on the arrangement of the registered task(s), the task arrangement unit 103 arranges the new task in the schedule. For example, if the new task can be arranged in an available time period of the schedule, the task arrangement unit 103 arranges the new task in the available time. For example, if the new task cannot be arranged in an available time slot of the schedule, the task arrangement unit 103 arranges, in an interrupting manner, the new task in the time slot in which the registered task is arranged.

The task arrangement unit 103 compares at least one of the deadline or the priority between the new task and the registered task to determine the time slot to be interrupted. The task arrangement unit 103 determines the arrangement of the new task, based on at least one of the deadline, the priority, the difficulty, or the work type of the new task.

The task rearrangement unit 104 changes the arrangement of the registered task determined by the task arrangement unit 103 to be interrupted. Changing the arrangement of a task means to change the time slot when the task is to be performed. The task rearrangement unit 104 determines the new arrangement of the registered task, based on at least one of the deadline, the priority, the difficulty, or the work type of the registered task.

The notification unit 105 notifies the user of the presence of a task that will not be completed before the deadline. For example, if the task arrangement unit 103 cannot arrange the new task in a time slot before the deadline, the notification unit 105 may notify the user that the new task will not be completed before the deadline. If the task rearrangement unit 104 cannot change the arrangement of the registered task, the notification unit 105 may notify the user that the registered task will not be completed before the deadline.

The screen output unit 106 transmits, to the user terminal 20, screen data for displaying a screen to be operated by the user. The screen data output (transmitted) by the screen output unit 106 includes screen data for displaying a task input screen and a schedule screen. The task input screen is a screen for inputting information on a new task. The schedule screen is a screen for displaying a schedule screen in which tasks are arranged. The screen output unit 106 generates screen data for displaying the schedule screen, based on the schedule information read from the schedule storage unit 100.

### Functional Configuration of User Terminal

As illustrated in FIG. 3, the user terminal 20 according to the present embodiment includes a screen display unit 201 and a task transmission unit 202.

The screen display unit 201 and the task transmission unit 202 are implemented by processes executed by the CPU 501, for example, as a result of the CPU 501 executing a program loaded from the HD 504 into the RAM 503 illustrated in FIG. 2.

The screen display unit 201 displays a screen to be operated by the user on the display 506, based on the screen data received from the task management apparatus 10. The screen displayed by the screen display unit 201 includes the task input screen and the schedule screen.

The task transmission unit 202 transmits new task information to the task management apparatus 10. The new task information is input by the user via the task input screen displayed by the screen display unit 201. All items of the new task information may be manually input by the user, or some of the items may be automatically input in the task input screen. The items to be automatically input may be complemented based on a registered task selected by the user.

### Procedure of Information Processing Method

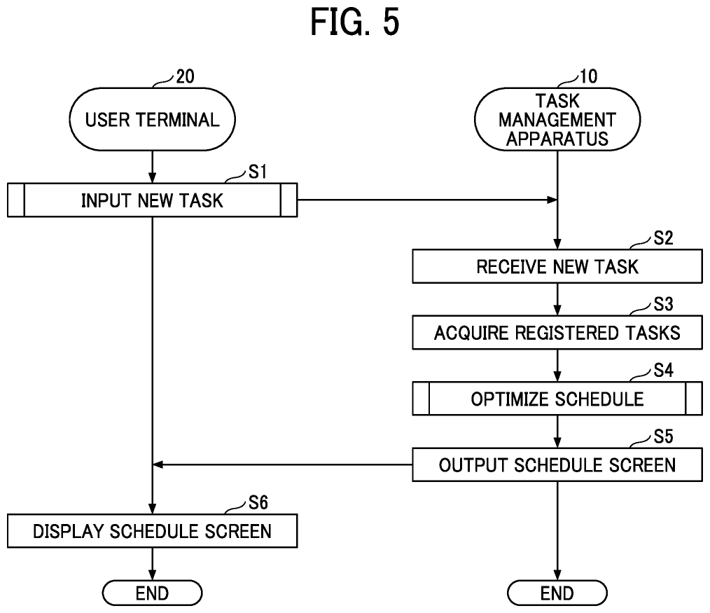

An information processing method performed by the information processing system 1 according to the present embodiment will be described with reference to FIGS. 5 to 12. FIG. 5 is a sequence diagram illustrating an example of the information processing method.

In step S1, the screen display unit 201 of the user terminal 20 displays the task input screen in response to a user operation. The screen display unit 201 may display an authentication screen before displaying the task input screen. In response to the user inputting authentication information (for example, an ID and a password) to the authentication screen, the user terminal 20 transmits the authentication information to the task management apparatus 10. The task management apparatus 10 performs a predetermined authentication process based on the received authentication information. If the authentication is successful, the task management apparatus 10 transmits the screen data for displaying the task input screen to the user terminal 20. The description is continued on the assumption that the authentication is successful.

The task transmission unit 202 of the user terminal 20 performs a task input process. The task input process is a process of acquiring the new task information input by the user in the task input screen. The task transmission unit 202 transmits the new task information acquired in the task input process to the task management apparatus 10.

### Task Input Screen

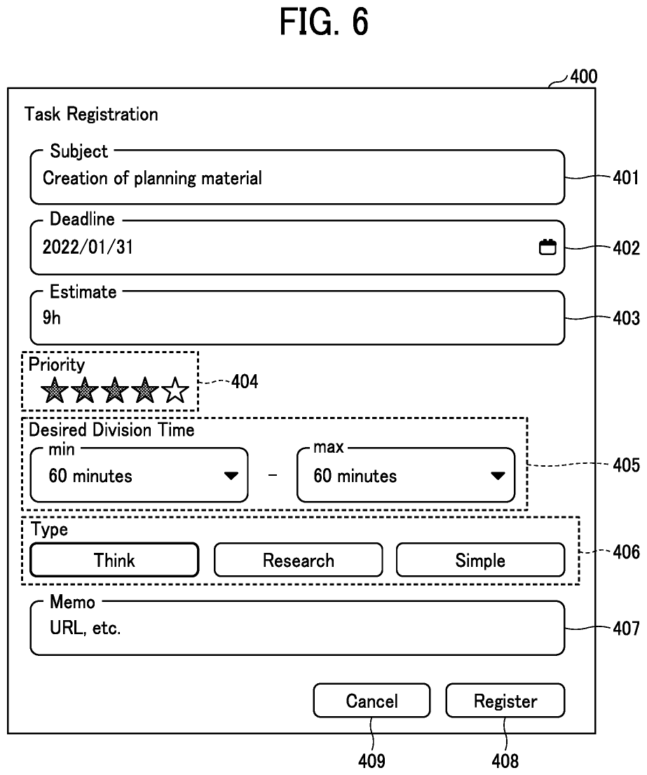

The task input screen according to the present embodiment will be described with reference to FIG. 6. FIG. 6 is a diagram illustrating an example of the task input screen.

As illustrated in FIG. 6, a task input screen 400 includes a subject input field 401, a deadline input field 402, an estimate input field 403, a priority input field 404, a desired division time input field 405, a type selection field 406, a memo input field 407, a register button 408, and a cancel button 409.

In the subject input field 401, a subject of a new task is input. In the deadline input field 402, the deadline of the new task is input. In the estimate input field 403, the work time of the new task is input. In the priority input field 404, the priority of the new task is input. In the desired division time input field 405, the division time units desired by the user are input. In the type selection field 406, the work type of the new task is selected. In the memo input field 407, a memo to be set for the new task is input.

In this example, the subject input field 401, the deadline input field 402, the estimate input field 403, the priority input field 404, and the desired division time input field 405 are required input items.

In response to the user pressing the register button 408, the new task information is generated based on the content input in the task input screen 400. In response to the user pressing the cancel button 409, the content input in the task input screen 400 is discarded and the task input screen 400 is closed.

### Task Input Process

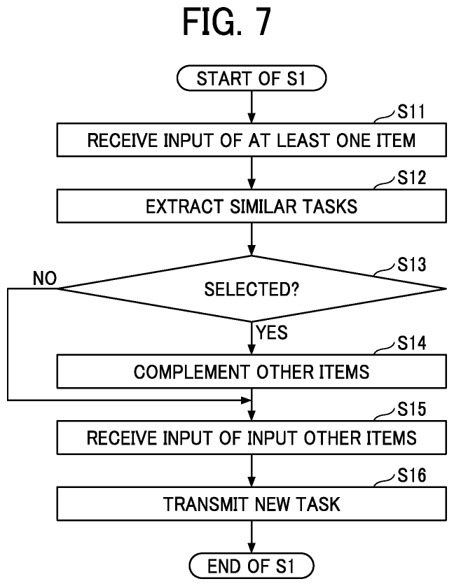

The task input process (step S1 of FIG. 5) according to the present embodiment will be described with reference to FIG. 7. FIG. 7 is a flowchart illustrating an example of the task input process according to the present embodiment.

In step S11, the task transmission unit 202 of the user terminal 20 receives at least one item input by the user in the task input screen 400. The at least one item is, for example, the subject or the work type. The task transmission unit 202 transmits a similar task acquisition request to the task management apparatus 10. The similar task acquisition request includes the at least one item of which the input has been received.

In step S12, the task management apparatus 10 receives the similar task acquisition request from the user terminal 20. The task acquisition unit 102 of the task management apparatus 10 extracts registered tasks from the schedule information stored in the schedule storage unit 100, based on the at least one item included in the similar task acquisition request.

For example, if the similar task acquisition request includes the subject, the task acquisition unit 102 extracts registered tasks having a subject similar to the subject, as the similar task. For example, if the similar task acquisition request includes the work type, the task acquisition unit 102 extracts registered tasks having the same work type.

The task acquisition unit 102 transmits the extracted registered tasks to the user terminal 20. The user terminal 20 receives the registered tasks from the task management apparatus 10. The screen display unit 201 of the user terminal 20 displays the received registered tasks in the task input screen 400.

Information to be displayed in the task input screen 400 desirably includes, for each of the registered tasks, the subject of the registered task, the estimate of the work time input by the user, and the actual total work time taken to complete the registered task. This allows the user to compare the work time estimated by the user with the actual work time of the past similar task, and thus to estimate the work time of the new task more accurately.

In step S13, the task transmission unit 202 of the user terminal 20 determines whether a registered task is selected by the user. If a registered task is selected by the user (YES), the task transmission unit 202 causes the process to proceed to step S14. On the other hand, if no registered task is selected by the user (NO), the task transmission unit 202 skips step S14 and causes the process to proceed to step S15.

In step S14, the task transmission unit 202 of the user terminal 20 complements the other items not input in the task input screen 400, based on the registered task selected by the user. For example, the task transmission unit 202 sets at least one of the work time, the priority, the division time units, or the work type of the selected registered task in the corresponding input field of the task input screen 400.

In step S15, the task transmission unit 202 of the user terminal 20 receives the other items input by the user in the task input screen 400. The task transmission unit 202 may receive editing of the item(s) complemented in step S14. The task transmission unit 202 performs step S15 until the required input fields are filled in the task input screen 400.

In step S16, the task transmission unit 202 of the user terminal 20 receives a task transmission operation performed by the user. The task transmission operation is, for example, an operation of pressing the register button 408. The task transmission unit 202 generates new task information, based on the content input in the task input screen 400. The task transmission unit 202 then transmits a new task registration request to the task management apparatus 10. The new task registration request includes identification information (for example, an ID of the authentication information) of the user and the new task information.

Referring back to FIG. 5, the description is continued. In step S2, the task input unit 101 of the task management apparatus 10 receives the new task registration request from the user terminal 20. The task input unit 101 acquires the identification information of the user and the new task information from the new task registration request. The task input unit 101 then sends the identification information of the user to the task acquisition unit 102. The task input unit 101 also sends the new task information to the task arrangement unit 103.

In step S3, the task acquisition unit 102 of the task management apparatus 10 receives the identification information of the user from the task input unit 101. Based on the identification information of the user, the task acquisition unit 102 reads the schedule information indicating the schedule of the user from the schedule storage unit 100. The task acquisition unit 102 acquires task information about the registered tasks arranged in the schedule, from the read schedule information. Hereinafter, task information about a registered task is also referred to “registered task information”. The task acquisition unit 102 sends the acquired registered task information to the task arrangement unit 103.

In step S4, the task arrangement unit 103 of the task management apparatus 10 receives the new task information from the task input unit 101. The task arrangement unit 103 also receives the registered task information from the task acquisition unit 102.

The task management apparatus 10 performs a schedule optimization process. The schedule optimization process is a process of adding the new task to the schedule to which the registered tasks are arranged and optimizing the arrangement of the new task and the registered tasks.

### Schedule Optimization Process

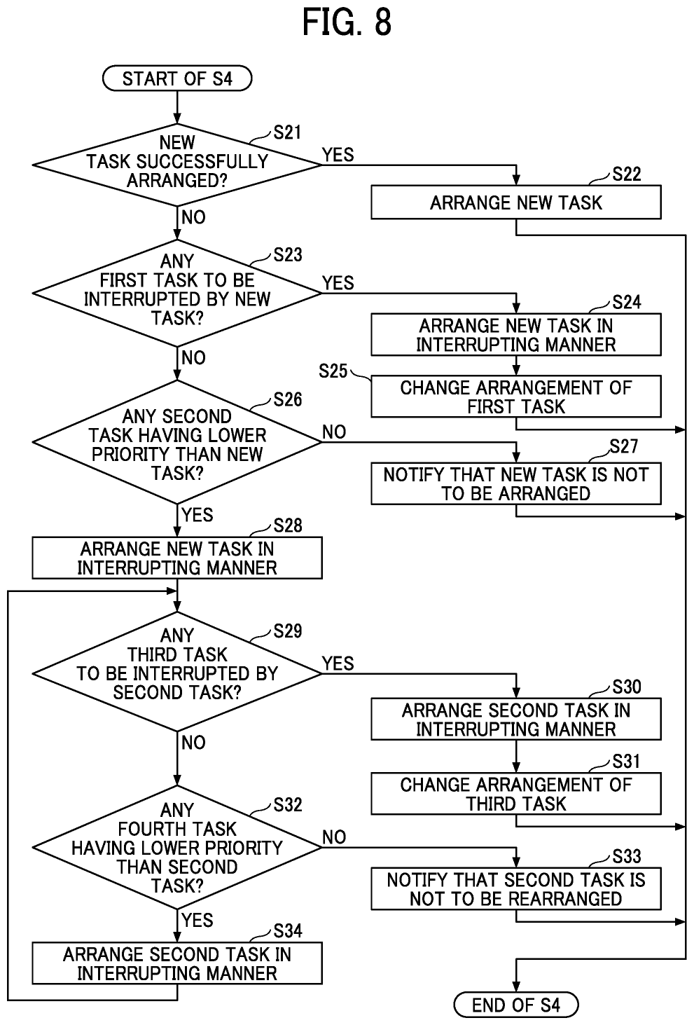

The schedule optimization process (step S4 of FIG. 5) according to the present embodiment will be described with reference to FIG. 8. FIG. 8 is a flowchart illustrating an example of the schedule optimization process according to the present embodiment.

In step S21, based on the new task information and the registered task information, the task arrangement unit 103 of the task management apparatus 10 determines whether the new task is to be arranged in an available time of the schedule. For example, the task arrangement unit 103 divides the new task by the division time units into a plurality of divisional tasks. If all the divisional tasks are arranged in the available time before the deadline, the task arrangement unit 103 may determine that the new task is to be arranged. On the other hand, if there is a divisional task that is not arranged in an available time before the deadline, the task arrangement unit 103 may determine that the new task is not to be arranged.

If the new task is to be arranged (YES), the task arrangement unit 103 causes the process to proceed to step S22. If the new task is not to be arranged (NO), the task arrangement unit 103 causes the process to proceed to step S23.

In step S22, the task arrangement unit 103 of the task management apparatus 10 arranges the new task in an available time in the schedule. The task arrangement unit 103 divides the new task by the division time units into a plurality of divisional tasks. Then, based on at least one of the deadline, the priority, the difficulty, or the work type of the new task, the task arrangement unit 103 determines available times in which the respective divisional tasks are arranged.

Specifically, the task arrangement unit 103 determines time slots in which the respective divisional tasks are arranged in accordance with a predetermined rule. An example of the predetermined rule is a rule of setting a time slot in which a task is preferentially arranged in accordance with the work type. Examples of such a rule include a rule of preferentially arranging a task of “think” type in the morning.

Another example of the predetermined rule is a rule of splitting a period by the deadline into a plurality of segments, and determining a segment in which the task is preferentially arranged in accordance with the priority, the difficulty, or the work type. A segment is, for example, each time slot obtained by dividing a period by the deadline by a predetermined number or a predetermined time length. For example, the rule may be such that a delay occurring degree is set in accordance with the work type, and a task of the work type having a high delay occurring degree is arranged in a first half of the period by the deadline in a concentrated manner. For example, the rule may also be such that a task with a high priority or high degree of importance is arranged in a first half of the period by the deadline in a concentrated manner.

The predetermined rule may be a rule of taking the priority, the difficulty, and the work type into account integrally. For example, the rule may be such that three values, which are values set for the respective items of the priority and the difficulty (values that increase as the priority and the difficulty increase) and a value set for each work type (value that increases as the delay occurring degree increases), are added together, and a proportion of the divisional tasks to be arranged in the first half of the period by the deadline is determined in accordance with the magnitude of the sum.

In step S23, the task arrangement unit 103 of the task management apparatus 10 determines whether a registered task (hereinafter, referred to as a “first task”) to be interrupted by the new task is present, based on the new task information and the registered task information.

For example, when an available time in which the new task is to be arranged is obtained if the arrangement of the registered task is changed to a time slot that is after the time slot in which the registered task is currently arranged and before the deadline of the registered task, the task arrangement unit 103 may determine that the first task is present. On the other hand, when an available time in which the new task is to be arranged is not obtained even if the arrangement of the registered task is changed to a time slot that is after the time slot in which the registered task is currently arranged and before the deadline of the registered task, the task arrangement unit 103 may determine that the first task is absent.

If the first task is present (YES), the task arrangement unit 103 causes the process to proceed to step S24. On the other hand, if the first task is absent (NO), the task arrangement unit 103 causes the process to proceed to step S26.

In step S24, the task arrangement unit 103 of the task management apparatus 10 arranges, in an interrupting manner, the new task in the time slot in which the first task determined in step S23 is arranged.

The task arrangement unit 103 may determine the arrangement of the new task according to the rule similar to the rule used in step S22.

In step S25, the task rearrangement unit 104 of the task management apparatus 10 changes the arrangement of the first task determined in step S23. The new arrangement of the first task is a time slot that is after the time slot in which the first task is currently arranged and before the deadline of the first task. The task arrangement unit 103 may determine the new arrangement of the first task according to the rule similar to the rule used in step S22.

In step S26, the task arrangement unit 103 of the task management apparatus 10 determines whether a registered task (hereinafter, referred to as a “second task”) with a lower priority than the new task is present, based on the new task information and the registered task information.

If the second task is absent (NO), the task arrangement unit 103 causes the process to proceed to step S27. On the other hand, if the second task is present (YES), the task arrangement unit 103 causes the process to proceed to step S28.

In step S27, the notification unit 105 of the task management apparatus 10 notifies the user that the new task is not to be arranged in a time slot before the deadline. Specifically, the notification unit 105 sends notification information indicating that the new task is not to be arranged in a time slot before the deadline to the screen output unit 106. The screen output unit 106 includes the notification information in screen data for displaying the schedule screen, and transmits the screen data to the user terminal 20.

In step S28, the task arrangement unit 103 of the task management apparatus 10 arranges, in an interrupting manner, the new task in the time slot in which the second task determined in step S26 is arranged.

The task arrangement unit 103 may determine the arrangement of the new task according to the rule similar to the rule used in step S22.

In step S29, the task rearrangement unit 104 of the task management apparatus 10 determines whether a registered task (hereinafter, referred to as a “third task”) to be interrupted by the second task determined in step S26 is present, based on the registered task information. The determination as to whether the third task is present is substantially the same as the determination as to whether the first task is present in step S23.

If the third task is present (YES), the task rearrangement unit 104 causes the process to proceed to step S30. On the other hand, if the third task is absent (NO), the task rearrangement unit 104 causes the process to proceed to step S32.

In step S30, the task rearrangement unit 104 of the task management apparatus 10 arranges, in an interrupting manner, the second task in the time slot in which the third task determined in step S29 is arranged. The task rearrangement unit 104 may determine the arrangement of the second task according to the rule similar to the rule used in step S22.

In step 531, the task rearrangement unit 104 of the task management apparatus 10 changes the arrangement of the third task determined in step S29. The task rearrangement unit 104 may determine the new arrangement of the third task according to the rule similar to the rule used in step S22.

In step S32, the task rearrangement unit 104 of the task management apparatus 10 determines whether a registered task (hereinafter, referred to as a “fourth task”) with a lower priority than the second task is present, based on the registered task information.

If the fourth task is absent (NO), the task rearrangement unit 104 causes the process to proceed to step S33. On the other hand, if the fourth task is present (YES), the task rearrangement unit 104 causes the process to proceed to step S34.

In step S33, the notification unit 105 of the task management apparatus 10 notifies the user that the second task is not to be arranged in a time slot before the deadline. Specifically, the notification unit 105 sends notification information indicating that the second task is not to be arranged in a time slot before the deadline to the screen output unit 106. The screen output unit 106 includes the notification information in screen data for displaying the schedule screen, and transmits the screen data to the user terminal 20.

In step S34, the task rearrangement unit 104 of the task management apparatus 10 arranges, in an interrupting manner, the second task in the time slot in which the fourth task determined in step S32 is arranged. The task rearrangement unit 104 may determine the arrangement of the second task according to the rule similar to the rule used in step S22.

Then, the task rearrangement unit 104 causes the process to return to step S29. At this time, the task rearrangement unit 104 sets the fourth task determined in step S32 as the new second task, and continues the process. The task rearrangement unit 104 repeatedly performs the processing from step S29 to step S34 until the arrangement of all the registered tasks is changed or any of the registered task is not to be arranged.

Referring back to FIG. 5, the description is continued. In step S5, the screen output unit 106 of the task management apparatus 10 reads the schedule information indicating the schedule of the user from the schedule storage unit 100. The screen output unit 106 generates screen data for displaying the schedule screen, based on the read schedule information. The screen data includes the schedule of the user. The screen output unit 106 transmits the generated screen data to the user terminal 20.

In step S6, the screen display unit 201 of the user terminal 20 receives the screen data from the task management apparatus 10. The screen display unit 201 displays the schedule screen on the display 506, based on the screen data. The schedule screen displays the schedule screen in which the tasks to be performed by the user are arranged.

### Schedule Screen

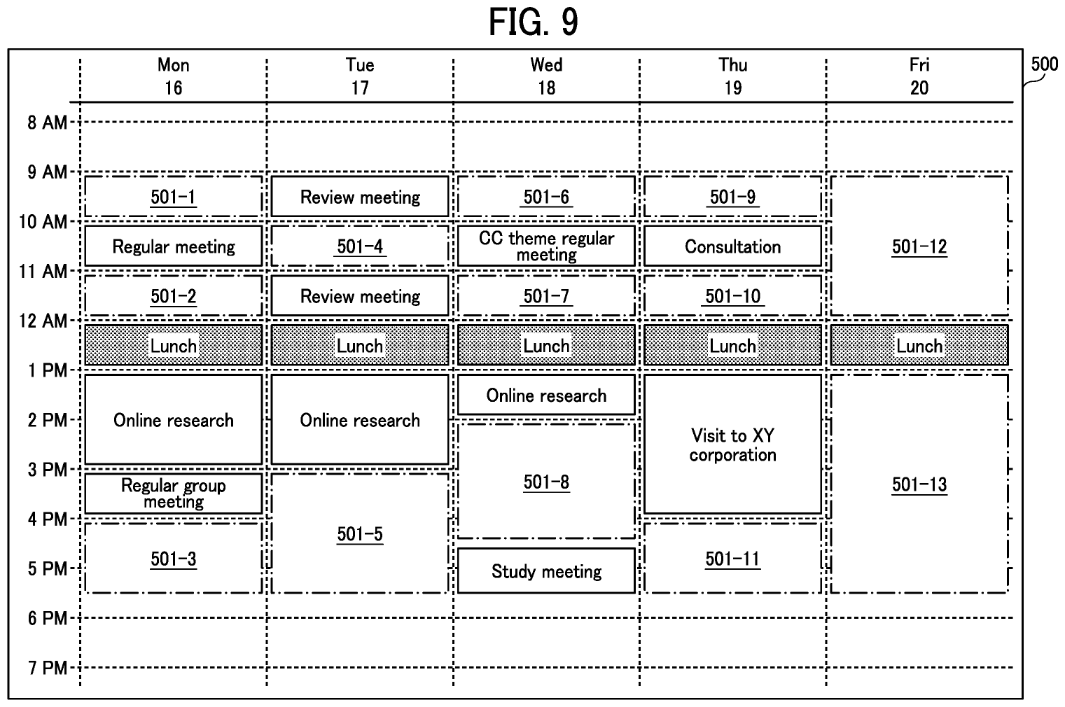

The schedule screen according to the present embodiment will be described with reference to FIGS. 9 to 12. FIGS. 9 to 12 are diagrams illustrating an example of the schedule screen according to the present embodiment.

FIG. 9 is an example of a schedule screen 500 before a new task is arranged. In FIG. 9, time slots 501-1 to 501-13 each surrounded by a one-dot-chain line are available times in which no task is arranged. As illustrated in FIG. 9, the schedule before the new task is arranged has many available times. Note that in the present embodiment, a time period from 9:00 AM to 5:30 PM of weekdays are set as working hours, and tasks are arranged within the working hours.

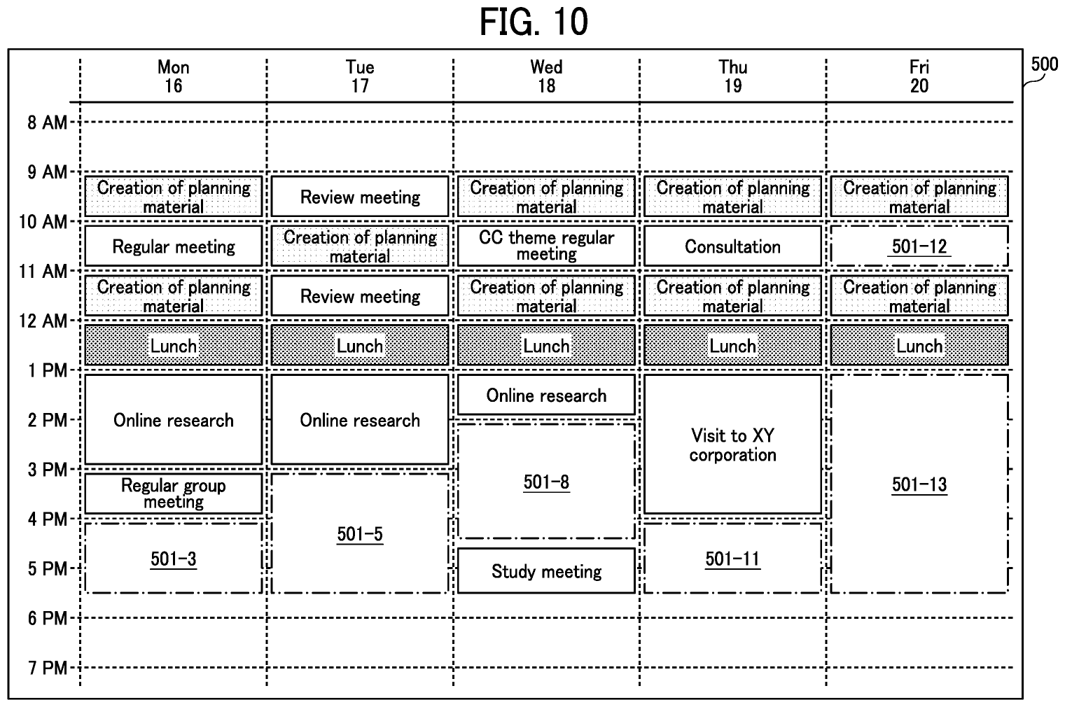

FIG. 10 is an example of the schedule screen 500 after a new task is arranged. In the example illustrated in FIG. 10, a new task having the subject “creation of planning material” is arranged. The new task “creation of planning material” is arranged in the available time slots 501-1, 501-2, 501-4, 501-6, 501-7, 501-9, 501-10, and 501-12 illustrated in FIG. 9. The schedule illustrated in FIG. 10 indicates that the new task is arranged without any change in the arrangement of the registered tasks.

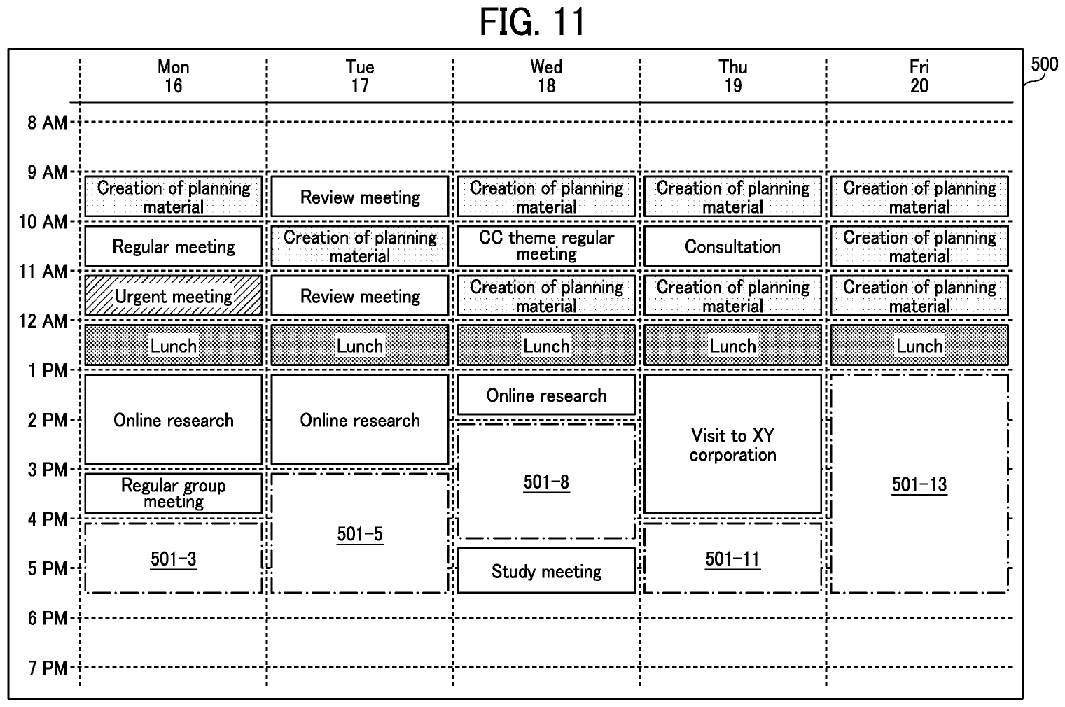

FIG. 11 is an example of the schedule screen 500 after a new task with a high priority is arranged. In the example illustrated in FIG. 11, a new task having the subject “urgent meeting” is arranged. The new task “urgent meeting” is arranged in the available time slot 501-2 illustrated in FIG. 9. In the schedule illustrated in FIG. 11, the arrangement of the registered task “creation of planning material” that has been arranged in the time slot 501-2 is changed to the available time slot 501-12 illustrated in FIG. 9. The schedule illustrated in FIG. 11 indicates that the arrangement of the registered task with a lower priority is changed in order to arrange the new task with a higher priority.

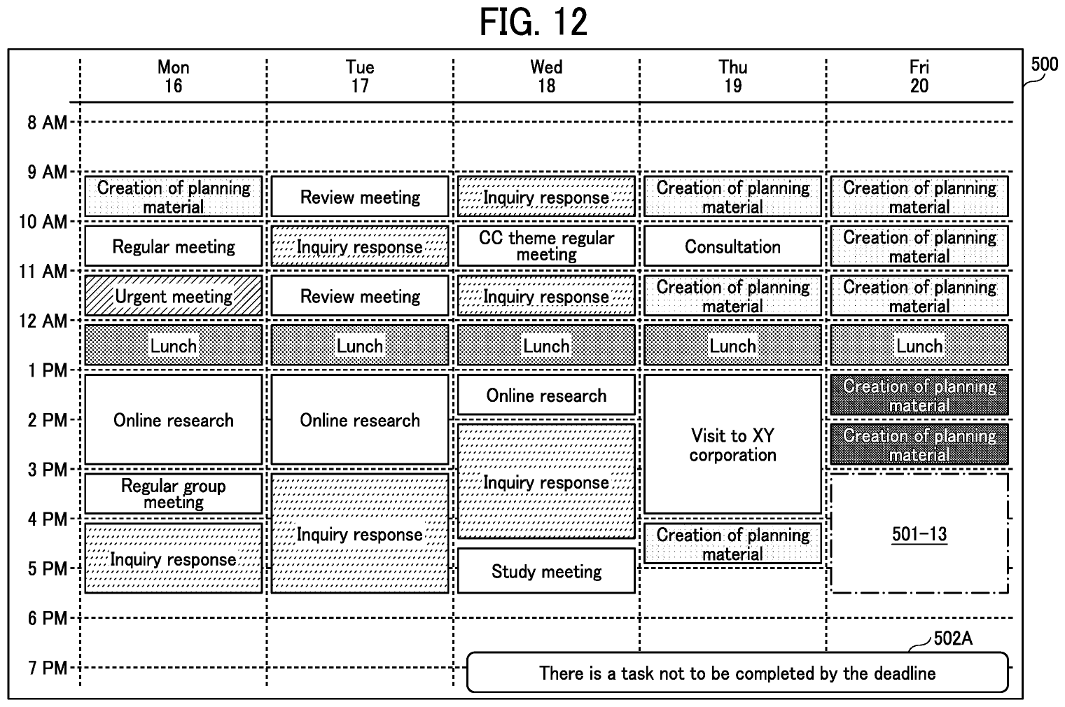

FIG. 12 is an example of the schedule screen 500 when the registered task is not to be arranged in a time slot before the deadline. In the example illustrated in FIG. 12, a new task having the subject “inquiry response” is arranged, and the arrangement of the registered task “creation of planning material” is changed. The registered task “creation of planning material” is a task of “think” type, and thus is to be arranged in the morning. In the schedule illustrated in FIG. 12, the registered task “creation of planning material” is rearranged in the afternoon of Friday. That is, not all the divisional tasks of the registered task “creation of planning material” are arranged in the time slots in the morning. The schedule screen 500 illustrated in FIG. 12 displays a notification 502A indicating that there is a task not to be completed by the deadline.

The task management apparatus 10 according to the present embodiment arranges a new task in a schedule, based on an arrangement of a registered task, and changes the arrangement of the registered task, based on an arrangement of the new task. The task management apparatus 10 may arrange the new task in a time slot in which the registered task is arranged. Thus, the present embodiment allows proper management of the schedule of tasks.

The task management apparatus 10 may arrange the new task in the schedule, based on a deadline or a priority. The task management apparatus 10 may arrange the new task in the schedule, based on a deadline, a priority, a difficulty, or a work type. Thus, the present embodiment allows a new task to be arranged in an appropriate time slot even when another task is registered.

The task management apparatus 10 arranges divisional tasks of the new task in the schedule, the divisional tasks being obtained by division of the new task by a preset time unit. The preset time unit is, for example, a time unit set by the user. Thus, the present embodiment allows a new task to be arranged even if a continuous available time is not present.

The task management apparatus 10 extracts registered tasks similar to a new task, and generates the new task based on a registered task selected by the user. Thus, the present embodiment allows the user to appropriately input a task with a simple operation.

The task management apparatus 10 issues a notification indicating that the new task or the registered task will not be completed before the deadline. The task management apparatus 10 may issue a notification indicating that the new task is not to be arranged before the deadline of the new task. The task management apparatus 10 may issue a notification indicating that the arrangement of the registered task is not to be changed before the deadline of the registered task. Thus, the present embodiment allows the user to reconsider the task to be performed when the task is not automatically arranged in the schedule.

### Second Embodiment

In the first embodiment, the configuration has been described in which a new task input by a user is arranged in a schedule. In a second embodiment, a configuration will be described in which a new task is arranged in a schedule in accordance with the progress of a registered task.

### Functional Configuration of Information Processing System

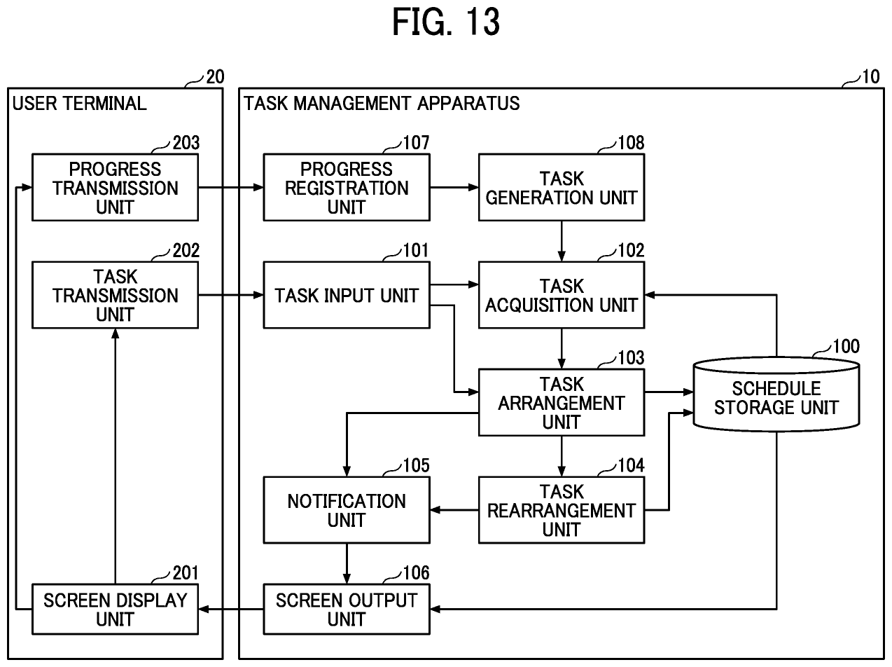

An example of a functional configuration of the information processing system 1 according to the present embodiment will be described with reference to FIG. 13. FIG. 13 is a block diagram illustrating an example of the functional configuration of the information processing system according to the present embodiment.

### Functional Configuration of Task Management Apparatus

As illustrated in FIG. 13, the task management apparatus 10 according to the present embodiment includes the schedule storage unit 100, the task input unit 101, the task acquisition unit 102, the task arrangement unit 103, the task rearrangement unit 104, the notification unit 105, the screen output unit 106, a progress registration unit 107, and a task generation unit 108. That is, the task management apparatus 10 according to the present embodiment further includes the progress registration unit 107 and the task generation unit 108, which is different from the first embodiment.

The progress registration unit 107 registers progress information of a registered task. The progress information is information indicating the progress of a task. The progress is a ratio of finished portion to the entire task. For example, when 100% indicates the completion of a task, the progress information is a value input as a percentage of the amount of completed work.

The task generation unit 108 generates a new task, based on the progress information input by the progress registration unit 107. Specifically, when it is expected that the registered task for which the progress information is input will not be completed before the deadline, the task generation unit 108 generates a new task for adding a work time for the registered task.

The new task generated by the task generation unit 108 corresponds to an additional work time for completing the registered task. For example, suppose that the progress information registered for the registered task indicates that a work time of two hours is to be added to complete the registered task.

In this case, the task generation unit 108 generates a new task for the work time of two hours. Note that items (such as the subject, the deadline, the priority, the division time units, and the work type) of the new task other than the work time are set to be the same as those of the registered task.

Screen data output by the screen output unit 106 according to the present embodiment further includes screen data for displaying a progress input screen. The progress input screen is a screen for inputting progress information of a registered task.

### Functional Configuration of User Terminal

As illustrated in FIG. 13, the user terminal 20 according to the present embodiment includes the screen display unit 201, the task transmission unit 202, and a progress transmission unit 203. That is, the user terminal 20 according to the present embodiment further includes the progress transmission unit 203, which is different from the first embodiment.

The progress transmission unit 203 transmits progress information of a registered task to the task management apparatus 10. The progress information is input by the user via the progress input screen displayed by the screen display unit 201.

### Procedure of Information Processing Method

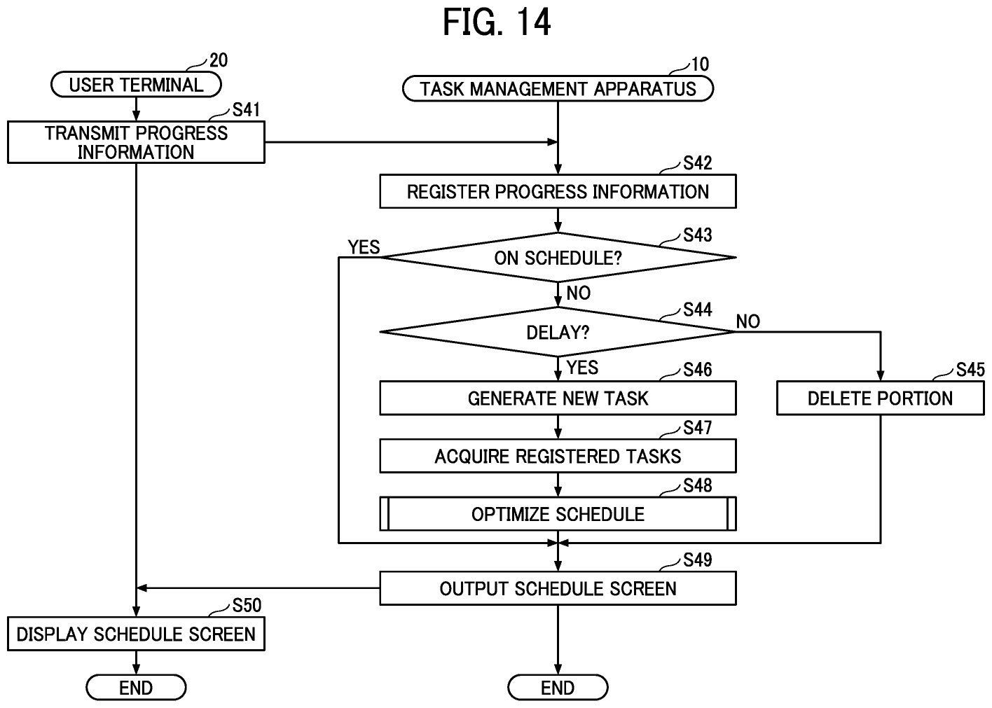

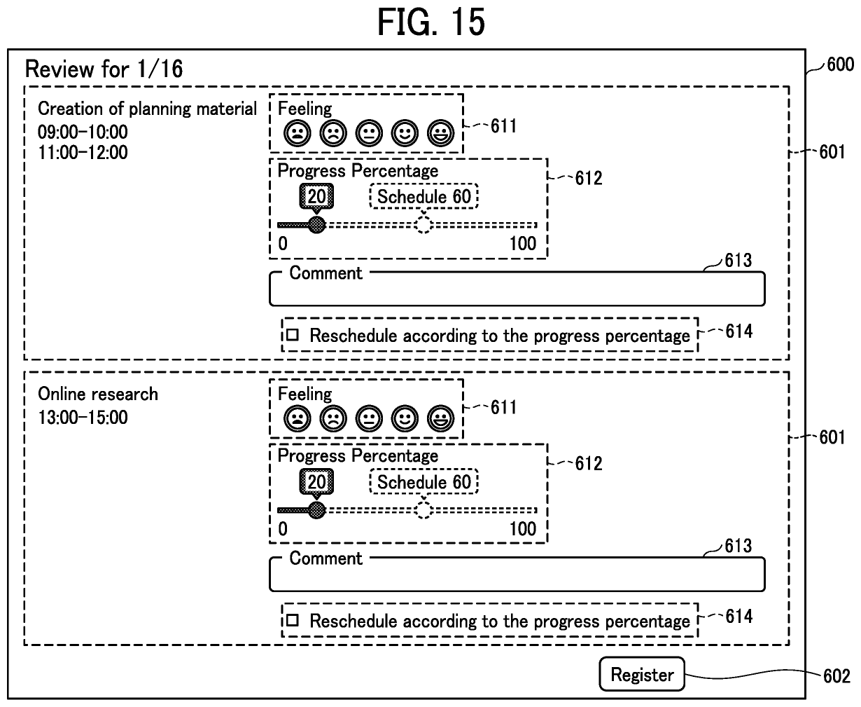

An information processing method performed by the information processing system 1 according to the present embodiment will be described with reference to FIGS. 14 and 15. FIG. 14 is a sequence diagram illustrating an example of the information processing method according to the present embodiment.

In step S41, the screen display unit 201 of the user terminal 20 displays the progress input screen in response to a user operation. The progress transmission unit 203 of the user terminal 20 generates progress information, based on the content input in the progress input screen. The progress transmission unit 203 transmits a progress information registration request to the task management apparatus 10. The progress information registration request includes information indicating the registered task and the progress information.

### Progress Input Screen

The progress input screen according to the present embodiment will be described with reference to FIG. 15. FIG. 15 is a diagram illustrating an example of the progress input screen according to the present embodiment.

As illustrated in FIG. 15, a progress input screen 600 includes progress input areas 601 and a transmission button 602. The progress input areas 601 each include a feeling input field 611, a progress percentage input field 612, a comment input field 613, and a rearrangement designation field 614. The progress input area 601 is displayed for each registered task.

In the feeling input field 611, the feeling of the user during execution of the task is input. In the progress percentage input field 612, the progress percentage of the task is input. In the comment input field 613, a comment about the task is input. The rearrangement designation field 614 is selected when the task is rearranged in accordance with the progress percentage.

In response to the user pressing the transmission button 602, the progress information is generated based on the content input in the progress input screen 600. The progress information is generated for each registered task for which the progress percentage is input.

Referring back to FIG. 14, the description is continued. In step S42, the progress registration unit 107 of the task management apparatus 10 receives the progress information registration request from the user terminal 20. The progress registration unit 107 acquires the information indicating the registered task and the progress information from the progress information registration request. The progress registration unit 107 stores the progress information of the registered task in the schedule storage unit 100, based on the information indicating the registered task.

In step S43, the progress registration unit 107 of the task management apparatus 10 determines whether the progress of the registered task is on schedule. The determination as to whether the progress is on schedule is performed by comparison of the input progress percentage with a scheduled progress percentage. The scheduled progress percentage is calculated based on the estimate work time and the already spent work time. The comparison of the progress percentages may permit a certain margin of error (for example, ±5%). That is, if the margin of error is within a predetermined range, the progress may be determined to be on schedule.

If the progress is not on schedule (NO), the progress registration unit 107 causes the process to proceed to step S44. On the other hand, if the progress is on schedule (YES), the progress registration unit 107 skips processing from step S44 to step S48, and causes the process to proceed to step S49.

In step S44, the progress registration unit 107 of the task management apparatus 10 determines whether the progress of the registered task is delayed. The progress being delayed indicates that the progress percentage is lower than the scheduled progress percentage.

If the progress is not delayed (NO), the progress registration unit 107 causes the process to proceed to step S45. On the other hand, if the progress is delayed (YES), the progress registration unit 107 sends the progress information of the registered task to the task generation unit 108 and causes the process to proceed to step S46.

In step S45, the progress registration unit 107 of the task management apparatus 10 deletes a portion of the registered task. If the progress is advanced relative to the schedule, it is expected that a portion of a time slot in which the registered task is arranged in the schedule becomes available. Thus, a portion of the registered task is deleted to increase the available time and allow another task to be arranged.

In step S46, the task generation unit 108 of the task management apparatus 10 receives the progress information of the registered task from the progress registration unit 107. The task generation unit 108 generates new task information corresponding to an additional work time to complete the registered task, based on the progress information of the registered task. The task generation unit 108 sends the generated new task information to the task arrangement unit 103.

Processing from step S47 to step S50 is substantially the same as the processing from step S3 to step S6 (see FIG. 5) in the first embodiment.

The task management apparatus 10 according to the present embodiment generates a new task, based on progress information of a registered task. When the registered task will not be completed before a deadline, the task management apparatus 10 may generate a new task for adding a work time for the registered task. Thus, the present embodiment allows proper management of the schedule of tasks based on the progress information of the tasks.

In each of the embodiments described above, the task management apparatus 10 is an example of an information processing apparatus. The user terminal 20 is an example of a terminal apparatus.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The apparatuses or devices described in the embodiments are just one example of plural computing environments that implement the embodiments disclosed herein. In some embodiments, the task management apparatus 10 may be implemented by a plurality of computing devices, together operating as a server cluster. The plurality of computing devices communicate with one another through any type of communication link including a network, shared memory, etc., and perform the processes disclosed herein.

The aspects of the present disclosure are as follows, for example.

According to Aspect 1, an information processing apparatus includes a task acquisition unit, a task arrangement unit, and a task rearrangement unit. The task acquisition unit acquires a registered task arranged in a schedule. The task arrangement unit arranges a new task in the schedule, based on the arrangement of the registered task. The task rearrangement unit changes the arrangement of the registered task, based on the arrangement of the new task.

According to Aspect 2, in the information processing apparatus of Aspect 1, the task arrangement unit arranges the new task in a time slot in which the registered task is arranged.

According to Aspect 3, in the information processing apparatus of Aspect 2, the task arrangement unit arranges the new task in the schedule, based on a deadline of the new task and a deadline of the registered task.

According to Aspect 4, in the information processing apparatus of Aspect 3, the task arrangement unit arranges the new task in a time slot in which the registered task having the deadline later than the deadline of the new task is arranged.

According to Aspect 5, in the information processing apparatus of Aspect 2, the task arrangement unit arranges the new task in the schedule, based on a priority of the new task and a priority of the registered task.

According to Aspect 6, in the information processing apparatus of Aspect 5, the task arrangement unit arranges the new task in a time slot in which the registered task with the priority lower than the priority of the new task is arranged.

According to Aspect 7, in the information processing apparatus of any one of Aspects 1 to 6, the task arrangement unit arranges the new task in the schedule, based on a deadline, a priority, a difficulty, or a work type of the new task.

According to Aspect 8, in the information processing apparatus of any one of Aspects 1 to 7, the task rearrangement unit changes the arrangement of the registered task, based on a deadline, a priority, a difficulty, or a work type of the registered task.

According to Aspect 9, in the information processing apparatus of any one of Aspects 1 to 8, the task arrangement unit arranges divisional tasks of the new task in the schedule, the divisional tasks being obtained by division of the new task by a preset time unit.

According to Aspect 10, the information processing apparatus of any one of Aspects 1 to 9, further includes a task input unit. The task input unit receives the new task input by a user.

According to Aspect 11, in the information processing apparatus of Aspect 10, the task input unit receives the new task input based on the registered task similar to the new task.

According to Aspect 12, the information processing apparatus of any one of Aspects 1 to 11, further includes a progress registration unit and a task generation unit. The progress registration unit receives progress information of the registered task input by a user. The task generation unit generates the new task, based on the progress information.

According to Aspect 13, in the information processing apparatus of Aspect 12, the task generation unit generates the new task for adding a work time for the registered task, in a case where the registered task is not completed before a deadline of the registered task.

According to Aspect 14, the information processing apparatus of any one of Aspects 1 to 13, further includes a notification unit. The notification unit issues a notification indicating that the new task is not completed before a deadline of the new task or the registered task is not completed before a deadline of the registered task.

According to Aspect 15, in the information processing apparatus of Aspect 14, the notification unit issues the notification in a case where any of divisional tasks of the new task is not to be arranged in a time slot before a deadline of the new task, the divisional tasks being obtained by division of the new task by a preset time unit.

According to Aspect 16, in the information processing apparatus of Aspect 14, the notification unit issues the notification in a case where any of divisional tasks of the registered task is not to be arranged in a time slot before a deadline of the registered task, the divisional tasks being obtained by division of the registered task by a preset time unit.

According to Aspect 17, an information processing system includes a terminal apparatus and an information processing apparatus to communicate with the terminal apparatus via a network. The terminal apparatus includes a task transmission unit and a screen display unit. The task transmission unit transmits a new task to the information processing apparatus. The screen display unit displays a screen including information on a schedule. The information processing apparatus includes a task acquisition unit, a task arrangement unit, a task rearrangement unit, and a screen output unit. The task acquisition unit acquires a registered task arranged in the schedule. The task arrangement unit arranges the new task in the schedule, based on the arrangement of the registered task. The task rearrangement unit changes the arrangement of the registered task, based on the arrangement of the new task. The screen output unit transmits screen data for displaying the screen to the terminal apparatus.

According to Aspect 18, an information processing method performed at an information processing apparatus, includes: acquiring a registered task arranged in a schedule; arranging a new task in the schedule, based on the arrangement of the registered task; and changing the arrangement of the registered task, based on the arrangement of the new task.

According to Aspect 19, a program causes an information processing apparatus to execute: acquiring a registered task arranged in a schedule; arranging a new task in the schedule, based on the arrangement of the registered task; and changing the arrangement of the registered task, based on the arrangement of the new task.

According to Aspect 20, a non-transitory recording medium storing a plurality of instructions which, when executed by one or more processors, causes the processors to perform an information processing method comprising: acquiring a registered task arranged in a schedule; arranging a new task in the schedule, based on the arrangement of the registered task; and changing the arrangement of the registered task, based on the arrangement of the new task.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing apparatus comprising:
processing circuitry configured to:
acquire a registered task arranged in a schedule;
arrange a new task in the schedule, based on the arrangement of the registered task; and
change the arrangement of the registered task, based on the arrangement of the new task.

2. The information processing apparatus of claim 1, wherein the circuitry is configured to arrange the new task in a time slot in which the registered task is arranged, and change the arrangement of the registered task to be in a time slot other than the time slot in which the new task is arranged.

3. The information processing apparatus of claim 2, wherein the circuitry is configured to arrange the new task in the time slot, based on a deadline of the new task and a deadline of the registered task.

4. The information processing apparatus of claim 3, wherein the circuitry is configured to arrange the new task in the time slot in which the registered task having the deadline later than the deadline of the new task is arranged.

5. The information processing apparatus of claim 2, wherein the circuitry is configured to arrange the new task in the schedule, based on a priority of the new task and a priority of the registered task.

6. The information processing apparatus of claim 5, wherein the circuitry is configured to arrange the new task in the time slot in which the registered task with the priority lower than the priority of the new task is arranged.

7. The information processing apparatus of claim 1, wherein the circuitry is configured to arrange the new task in the schedule, based on at least one of a deadline, a priority, a difficulty, or a work type of the new task.

8. The information processing apparatus of claim 1, wherein the circuitry is configured to change the arrangement of the registered task, based on at least one of a deadline, a priority, a difficulty, or a work type of the registered task.

9. The information processing apparatus of claim 1, wherein the circuitry is configured to arrange divisional tasks of the new task in the schedule, the divisional tasks being obtained by dividing the new task by a preset time unit.

10. The information processing apparatus of claim 1, wherein the circuitry is configured to receive the new task input by a user.

11. The information processing apparatus of claim 10, wherein the circuitry is configured to receive the new task input based on the registered task similar to the new task.

12. The information processing apparatus of claim 1, wherein the circuitry is configured to:
receive progress information of the registered task input by a user; and
generate the new task, based on the progress information.

13. The information processing apparatus of claim 12, wherein the circuitry is configured to generate the new task for adding a work time for the registered task, in a case where the registered task is not completed before a deadline of the registered task.

14. The information processing apparatus of claim 1, wherein the circuitry is configured to issue a notification indicating that the new task is not completed before a deadline of the new task or the registered task is not completed before a deadline of the registered task.

15. The information processing apparatus of claim 14, wherein the circuitry is configured to issue the notification in a case where any of divisional tasks of the new task is not to be arranged in a time slot before a deadline of the new task, the divisional tasks being obtained by dividing the new task by a preset time unit.

16. The information processing apparatus of claim 14, wherein the circuitry is configured to issue the notification in a case where any of divisional tasks of the registered task is not to be arranged in a time slot before a deadline of the registered task, the divisional tasks being obtained by dividing the registered task by a preset time unit.

17. An information processing system comprising:
the information processing apparatus of claim 1; and
a terminal apparatus communicably connected with the information processing apparatus via a network, wherein
the terminal apparatus includes terminal apparatus circuitry configured to:
transmit the new task to the information processing apparatus; and
display a screen including information on the schedule on a display, and
the processing circuitry of the information processing apparatus is further configured to transmit screen data for displaying the screen to the terminal apparatus.

18. An information processing system comprising:
processing circuitry configured to:
in response to input of a new task, acquire a registered task arranged in a schedule;
arrange the new task in the schedule, based on the arrangement of the registered task;
change the arrangement of the registered task, based on an arrangement of the new task; and
display a screen including information on the schedule.

19. An information processing method comprising:
acquiring a registered task arranged in a schedule;
arranging a new task in the schedule, based on the arrangement of the registered task; and
changing the arrangement of the registered task, based on the arrangement of the new task.
